(19) United States
(12) Patent Application Publication
(10) Pub. No.: US 2022/0318650 A1
(43) Pub. Date: Oct. 6, 2022

(54) Computational Quantification of an Entity's Affinity to a Qualitative Issue Defined with Boolean Data

(71) Applicant: Vidaloop, Inc., La Mesa, CA (US)

(72) Inventors: Ryan Scott Cook, La Mesa, CA (US); Andrew Phillip Groff, San Diego, CA (US)

(21) Appl. No.: 17/218,154

(22) Filed: Mar. 30, 2021

(51) Int. Cl. G06N 5/04

(52) U.S. Cl. CPC G06N 5/04

(57) ABSTRACT

Provided are methods and systems for computational quantification of an entity's affinity to a qualitative issue defined with Boolean data in a computing system. The disclosed invention provides for a system for rating a first entity's affinity to an issue through information provided by the entity itself, or derived from information provided by other entities related to the first entity. Further, a first entity's affinity to a group of political issues defined as an umbrella issue can also be rated. With the present system, qualitative data is utilized to quantify an entity's affinity to a topic or issue.

### FIELD OF THE TECHNOLOGY

This application relates generally to computational methodologies for quantifying an entity's affinity to a qualitative topic, with information provided by various sources.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

Provided herein are methods and systems for determining a quantitative score value that represents a first entity's qualitative affiliation with a political issue. In some embodiments, the method comprises: receiving a selection of a political issue; defining a plurality of affirmative stances for the political issue; allocating a strength number to each of the plurality of affirmative stances, each strength number representing the affirmative stance's importance to the political issue; allocating a position to each affirmative stance, the position representing the first entity's agreement or disagreement with the affirmative stance; determining a numerical strength value for each of the plurality of affirmative stances, the numerical strength value being either the strength number for the affirmative stance, or an invert of the strength number for the affirmative stance; determining a quantitative score value that represents the first entity's qualitative affiliation with the political issue based on a ratio of summed numerical strength values compared to summed strength numbers; and displaying the quantitative score value that represents the first entity's qualitative affiliation with the political issue via a graphical user interface to an end user on a computing device.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF THE DRAWINGS

Exemplary embodiments are illustrated by way of example and not limitation in the figures of the accompanying drawings, in which like references indicate similar elements.

FIG. 1 depicts an exemplary simplified environment for a system for rating affinity to an issue.

FIG. 2 depicts relationships between exemplary database objects that may be stored in a database of the system for rating affinity to an issue.

FIG. 3 depicts an exemplary chart of a politician's calculated issue score for an exemplary issue.

FIG. 4 depicts a limited fictional example depicting a politician's stances on various issues that make up an exemplary umbrella issue.

FIG. 5 depicts exemplary data relationships in a database of the disclosed system between interest groups, positions, stances, issues, and politicians.

FIG. 6 depicts an exemplary politician profile that may be displayed on a graphical user interface of a client user device.

FIG. 7 depicts an exemplary detailed profile for an issue that may be displayed on a graphical user interface of a client user device.

FIG. 8 depicts an exemplary method for deriving an exemplary politician's rating for an issue.

FIG. 9 depicts an exemplary graphical user interface that may be displayed on a client user device.

FIG. 10 depicts another exemplary graphical user interface that may be displayed on a client user device.

FIG. 11 depicts another exemplary graphical user interface that may be displayed on a client user device.

FIG. 12 shows a diagrammatic representation of a computing device for a machine in the exemplary electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, and other embodiments can be formed, by introducing structural and logical changes without departing from the scope of what is claimed. The following detailed description is, therefore, not to be taken in a limiting sense and the scope is defined by the appended claims and their equivalents.

In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The embodiments disclosed herein may be implemented using a variety of technologies. For example, the methods described herein may be implemented in software executing on a special purpose computer system containing one or more computers, or in hardware utilizing either a combination of microprocessors or other specially designed application-specific integrated circuits (ASICs), programmable logic devices, or various combinations thereof. In particular, the methods described herein may be implemented by a series of computer-executable instructions residing on a storage medium, such as a disk drive, or computer-readable medium.

One way to empower voters to make informed decisions about politicians and political issues is by providing accurate and relevant information to the voter. The present application discloses a computational system for rating affinity to a political issue, also sometimes referred to herein as simply the “system”. The system comprises a back-end where an administrator can input information regarding political issues, and a front-end where a user can view the output numerical ratings and related information for various political issues and entities.

The management and display of issues, issue stances, and positions is a critical component of the presently disclosed system. With this system, a voter can clearly see which politicians truly align with their values and feel empowered to make informed choices at the ballot box.

At a high level, the term “issues” or “political issues” as used herein refers to broad-stroke concerns for the public. An issue may be a common theme under which more nuanced sentiments can be grouped. Exemplary issues include, but are not limited to, “gun rights,” “abortion,” “racial justice”, “healthcare”, “gender equality”, etc. In general, issues collect a set of related stances.

As used herein, the term “entity” relates to anything that can have an opinion or make a judgment about an issue. Exemplary entities include, but are not limited to, a person, an interest group, or a sentient artificial intelligence engine. An “interest group” as used herein refers to a person or group of people who work in promotion or detraction of one or several issues. This can include organizations such as the NRA (National Rifle Association), the ACLU (American Civil Liberties Union), lobbying firms, or even individual lobbyists.

Each issue has several “stances”, which are more nuanced agree/disagree statements. Generally, a stance is a yes or no statement designed to capture an entity's opinion regarding one aspect of an issue. Exemplary stances include, but are not limited to, “Abortion should be legal within the first trimester of pregnancy”, “There should be a ban on assault weapons”, “Pineapple belongs on pizza”, or “Pineapple is a critical component of fruit salad”. A stance can relate to more than one issue, in which case more than one issue-stance relationship will be defined and stored in a database of the presently disclosed system.

People or organizations are connected to stances through “positions”, which indicate whether the entity agrees or disagrees with the sentiment represented by the stance. A position represents a particular entity's opinion on an aspect of an issue; it is essentially the “yes” or “no” answer to the question posed by a stance. In some embodiments of the present system, positions also capture the importance of that aspect to the entity's overall concept of the issue. For example, a strongly pro-pineapple person might take a “yes” position on the stance “Pineapple belongs on pizza” and mark it as most important. This would give that person a higher pro-pineapple score than someone who took all of the same positions but instead marked this one as not very important. A position is related to a single stance and a single entity.

Once all the positions for the stances for a particular issue are determined, a “rating” can be generated by the system disclosed herein. In general, a rating is a numeric score assigned to one entity. Sometimes a rating is a numeric score assigned to one entity by another entity. An entity organization may give a letter grade instead of a numeric rating. These are then converted into numeric scores by the presently disclosed system.

An aggregation of all known ratings for an entity over a particular issue make up an “issue rating”. Using the pineapple example discussed above, a person might have a pineapple issue rating of 8.3 (out of 10) combined from ratings by three separate pizza restaurants. The details of how issue ratings are calculated for people and for interest groups is detailed further herein.

System Architecture

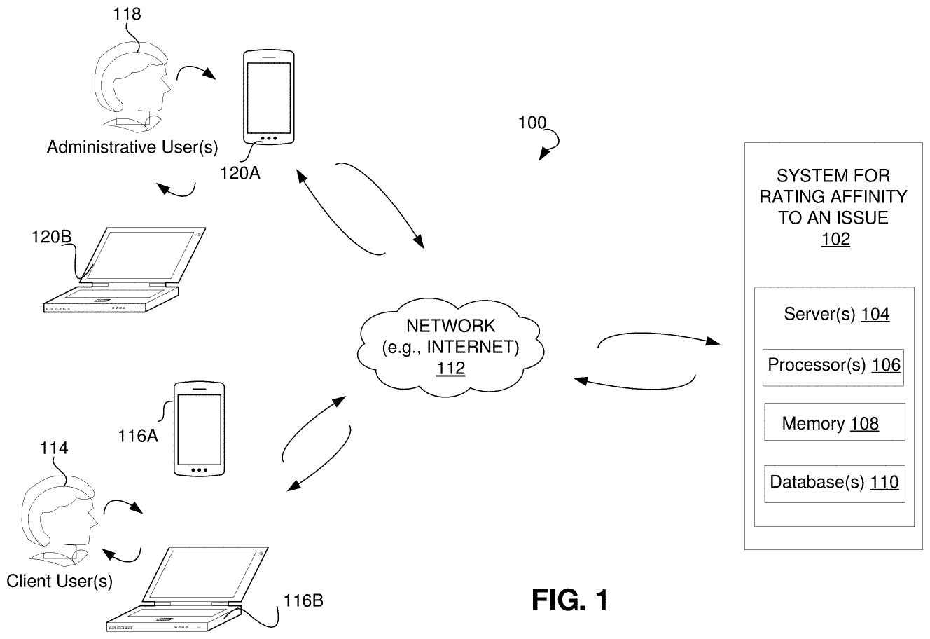

FIG. 1 depicts an exemplary simplified environment 100 for a system for rating affinity to an issue. In exemplary embodiments, the system for rating affinity to an issue 102 is a server-based distributed software application, thus the system 102 may include a central component residing on a server 104 and one or more client applications residing on one or more user devices and communicating with the central component via the network 112. Users may communicate with the system 102 via a dedicated client application available through user devices, or via a web browser on any internet-enabled computing device.

System 102 may comprise software application(s) for receiving, processing, analyzing, and outputting data to and from any computing device, including but not limited to, computing devices 116A, 116B, 120A, and 120B. In exemplary embodiments, at least some components of system 102 operate on one or more cloud computing devices or servers. Server(s) 104 may comprise at least one processor 106, memory 108, and database 110.

Processor(s) 106 may be any suitable hardware processor for executing the software program on server(s) 104. Processor(s) 106 may include a programmable processor, such as a microcontroller, central processing unit (CPU), and so forth. In other embodiments, the processor(s) 106 may include an application-specific integrated circuit or programmable logic array, such as a field programmable gate array, designed to implement the functions performed by the system for rating affinity to an issue 102.

Memory 108 may comprise static and/or dynamic memory. Database(s) 110 may be any data structure capable of containing information for use by the system 102. Database(s) 110 may include computer-readable instructions for execution by processor 106.

In various embodiments, the system for rating affinity to an issue 102 may be installed on a user computing device or may be provided as a cloud service residing in a cloud storage. The operations performed by the processor 106 and the database 110 are described in further detail herein.

The system for rating affinity to an issue 102 may further be in communication with administrative user(s) 118, and client users 114. There may be additional components in communication with system 102 than those depicted in exemplary FIG. 1. For example, though not depicted in exemplary FIG. 1, system 102 may further be in communication with one or more other entities.

In various embodiments, administrative user(s) 118 may access data from system 102 on administrative user device 120 (depicted as exemplary administrative user devices 120A and 120B in FIG. 1), which is in communication with system 102 via network 112. Administrative user device 120 may be any computing device with a graphical user display and input mechanisms available to administrative user 118, including but not limited to, a smartphone, tablet, smartwatch, laptop computer, and desktop computer. Further, administrative user device 120 may be a wireless-enabled device, as defined here. In addition, system 102 may send alerts to administrative user device 120 in the form of a pop-up alert, text message, email message, phone call, or any other means of communicating with administrative user device 120.

Client user(s) 114 may also access data from system 102 on client user device 116 (depicted as exemplary client user devices 116A and 116B in FIG. 1), which is in communication with system 102 via network 112. Client user device 116 may be any computing device with a graphical user display and input mechanisms available to client user 114 including but not limited to, a smartphone, tablet, smartwatch, laptop computer, and desktop computer. Further, client user device 116 may be a wireless-enabled device, as defined here. In exemplary embodiments, system 102 may send alerts to client user device 116 in the form of a pop-up alert, text message, email message, phone call, or any other means of communicating with client user device 116. In various embodiment, the entities discussed herein are typically client user(s) 114 that send and receive information to system 102.

The network 112 may include the Internet or any other network capable of communicating data between devices. Suitable networks may include or interface with any one or more of, for instance, a local intranet, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection.

Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The network 112 can further include or interface with any one or more of an RS-232 serial connection, an IEEE-1394 (FireWire) connection, a Fiber Channel connection, an IrDA (infrared) port, a SCSI (Small Computer Systems Interface) connection, a Universal Serial Bus (USB) connection or other wired or wireless, digital or analog interface or connection, mesh or Digi® networking.

The network 112 may be a network of data processing nodes that are interconnected for the purpose of data communication. The network 112 may include any suitable number and type of devices (e.g., routers and switches) for forwarding commands, content, requests, and/or responses between each system 102 and connected devices.

Organization of Information in Database

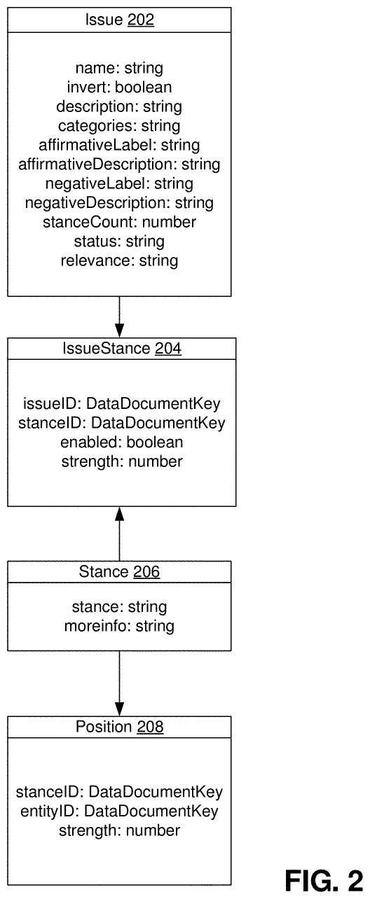

FIG. 2 depicts relationships between exemplary database objects that may be stored in database 110 of the system for rating affinity to an issue 102. FIG. 2 depicts a core issue 202 (also sometimes referred to herein as simply issue 202), stance 206, and position 208 database objects. Further, parts of issue 202 and stance 206 database objects can be combined to yield the database object of IssueStance 204.

With the present system, a full-featured administrative user interface is generated, allowing an administrator user 118 to manage issues 202, stances 206, positions 208, and the connections therebetween. In an exemplary embodiment, an administrative user 118 may list special interest groups in database 110, display and edit the issues 202 with which an interest group is concerned, list issues 202, display and edit the stances 206 and positions 208 related to the issue 202. Further, a client user interface is generated to allow client user(s) 114 to view the data in a user friendly way, such as by showing an entity's top issues and ratings for those issues on a profile page present in system 102.

Issues Database and Issue Object

As discussed herein, one part of the system 102 is a database 110 of issues. In exemplary embodiments, the database is broken into several objects which combine to reflect the complex world of political issues and the stances that people or organizations take on those issues.

One central object to the system 102 is the issue object. The issue object is key to the disclosed methodology for normalizing political issues. The issue object is composed of four core properties: the issue name, an affirmative label, a negative label, and a Boolean property “invert”. Each issue has two sides to it which represent the more extreme positions, with most people falling somewhere in between the two extremes. Two separate labels are utilized to allow the system to display the issue in a way that is preferable to people on either side of the issue. Using abortion as an example, the system does not designate a politician as being pro-abortion or anti-abortion. Instead, labels that are commonly associated with each stance are used, such as “pro-choice” or “pro-life”.

Continuing with the abortion issue example, the issue object in the database would have the following four properties: issue name=abortion, affirmative label=pro-choice, negative label=pro-life, invert=yes.

When a person or group is scored on the abortion issue, they will end up with a negative or positive value. Negative values will (generally) be inverted to a positive number. Then, the score will be converted into a percentage. If the initial value was negative, the system displays the negative label. If the initial value as positive, the system displays the positive label. Thus, the system can display a person or organization's stance on an issue as “Pro-Life (85%)” or “Pro-Choice (20%)” The label reflects the overall stance, and a numeric value represents the strength.

Where possible, the system attempts to find two flattering ways to state opposing stances on an issue. Sometimes, this is not possible. For example, with women's rights, there typically are no groups that represent themselves as being “anti-women's rights”. However, there are still clear cases of policies and votes that are against the interest of women's rights. In this example, the system will classify the women's rights issue as a non-inverted issue. This means it has no negative label, so it will get displayed as a negative value directly.

While issues vary dramatically in the real world, building a normalized view for them requires being able to define two clear sides. Where there are not naturally two sides to an issue, often it can be broken down into what should be done about the issue. One side thinks nothing needs to be done and the other side has several measures that are perceived as solutions or improvements to the issue.

Stances

While issues represent the higher level things that people care about, they do not accurately capture nuance very well. To address this problem, the system utilizes “stances”. Stances are true/false statements where a “true” response relates to an issue's affirmative label, and a “false” response relates to an issue's negative label. The stance 206 database object is typically composed of a single statement.

Continuing with the abortion example, some example stances might be: “Generally, Abortion should be legal within the first trimester of pregnancy” or, “Abortion should be legal whenever the pregnancy endangers the Mother's Life”.

Since the affirmative label for abortion is “Pro-Choice,” these stances are all phrased in a pro-choice way. In some cases, it might be necessary for a stance to relate to an issue in the opposite way—for example, a pro-life stance. The system can handle this case when a stance's relationship to an issue is defined in the IssueStance 204 object. However, for consistency, the system generally utilizes stances worded in favor of the Affirmative label. An example pro-life stance might be “having an abortion is morally wrong”.

Issue-Stance Relationship

A significant portion of a stance 206 comes in its relationship to an issue 202. A single stance 206 can have relationships to multiple issues. In exemplary embodiments, the IssueStance 204 object has a single property, “strength”, which represents how strong of an impact this stance 206 has on the issue 202. The value for strength can range between −10 and 10 in example embodiments, though a person of ordinary skill in the art would understand that other values may be used instead of this particular range.

Generally, a mix of positive and negative values is utilized by the system 102 so that users feel like their stance is represented positively about half the time. In those cases, a user might have a positive relationship to one issue and a negative relationship to another.

Determining values for issue-stance relationships may be a judgement call made by an administrative user 118. As a general guideline, the more a stance is “issue defining” the more points it is allocated in the system. Stances that are more fringe or generally have a small impact on the issue should have the smallest values for their strength.

Continuing with the abortion issue, a stance like “Generally, Abortion should be legal within the first trimester of pregnancy” might have a full ten points, since that stance largely defines a person's position on abortion. Consider a stance like “Abortion should be legal whenever the pregnancy endangers the Mother's Life.” It might seem like this stance should be worth a lot of points because anyone who says no to that is probably very anti-abortion, and should get a high negative value. However, people who say no to that will get a lot of negative points from other more impactful stances, and someone who says yes to that stance could still be very pro-life. Therefore, this stance deserves relatively few strength points—maybe 1 or 2.

Positions

In the disclosed system, a position 208 is the object that defines a person or organization's feelings about a stance 206. Given a stance like “Same sex marriage should be legal”, an entity's position on that stance would either be “true” or “false.” As discussed herein, an “entity” can be either a person, a group of persons, or an organization.

Scoring

At the core of the system 102 disclosed herein are issues 202. Each issue 202 has many stances 206. Stances 206 are associated with issues 202 using a strength score which indicates how significant a stance 206 is to an issue 202. One stance 206 can relate to multiple issues, and have a different strength score per issue 202. Positions 208 are a relationship between an entity (Person or group) and a stance 206. Positions are generally true or false, representing the entity's position 208 on the stance 206.

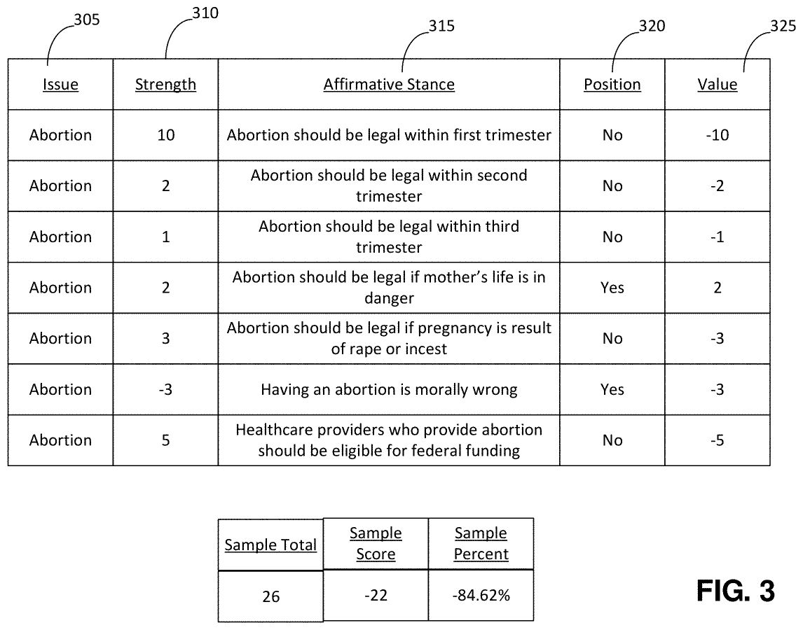

For each issue 202 for an entity, a strength score can be determined by the system 102 to quantify the entity's qualitative position for each stance 206. FIG. 3 depicts an exemplary chart of a politician's calculated issue score for an exemplary issue of abortion. As would be understood by persons of ordinary skill in the art, there may be fewer or additional columns than those depicted in exemplary FIG. 3. Further, a similar chart can be generated from the system database for any one or more issues, and for any one or more stances.

In exemplary FIG. 3, column 305 depicts that the issue is abortion. Column 310 depicts a total strength value allocated to each stance related to the issue. Column 315 lists each applicable stance to the issue of abortion, stated in an affirmative tone. Column 320 depicts whether the politician agrees or disagrees with the stance. Column 325 depicts the score value applied to each stance based on the strength value and the politician's position.

Seven abortion stances are shown in FIG. 3, though fewer or additional stances may be depicted in various embodiments. Since the politician believes abortion should only be an option when the life of the mother is at risk, a pro-life position is assigned to him in the system on every stance except that one. This gives him a negative value on every stance except that one, where he gets two points towards being pro-choice.

In this example, each affirmative stance is designated a strength value from −10 to 10. However, adding up all the strength values for all the stances yields a total value for the issue of abortion as a whole. In this example, the range of points available to this politician for the issue of abortion is −26 to 26. The politician scores −22 on this scale. Dividing −22 by 26 yields the percentage of −84.62%. Since the Negative Label on abortion is “Pro-Life” this means the system can display the politician's score as “Pro-Life (85%)”.

Note that in the above example we have one stance with a negative strength: “Having an abortion is morally wrong.” That is there as an example to demonstrate that negative strengths do also work in this system. For consistency, we would probably re-phrase the stance as “Having an abortion is morally acceptable.” and then give that a score of positive three. Both options produce identical results in practice. Positive scores are preferred for consistency and to simplify database maintenance.

Umbrella Issues

The disclosed systems and methods may also be used to score umbrella issues, which are above individual issues, and may be stored as a separate object in database 110 of system 102. An umbrella issue consists of a stance on several issues grouped together. For example, one umbrella issue could be the “Democratic Party Platform” which would be “Pro-Choice, Pro-Gun Control, Pro-Immigrant Rights, etc.” A relationship between an issue and an umbrella issue will also have strength scores to indicate how important an individual issue is to the overall platform of the umbrella issue. Umbrella issues allow the system to roll up multiple issues into a single score. For example, “Progressive” and “Conservative” umbrella issues can be defined to allow one to see how closely a politician or other entity aligns with each of those two ideologies.

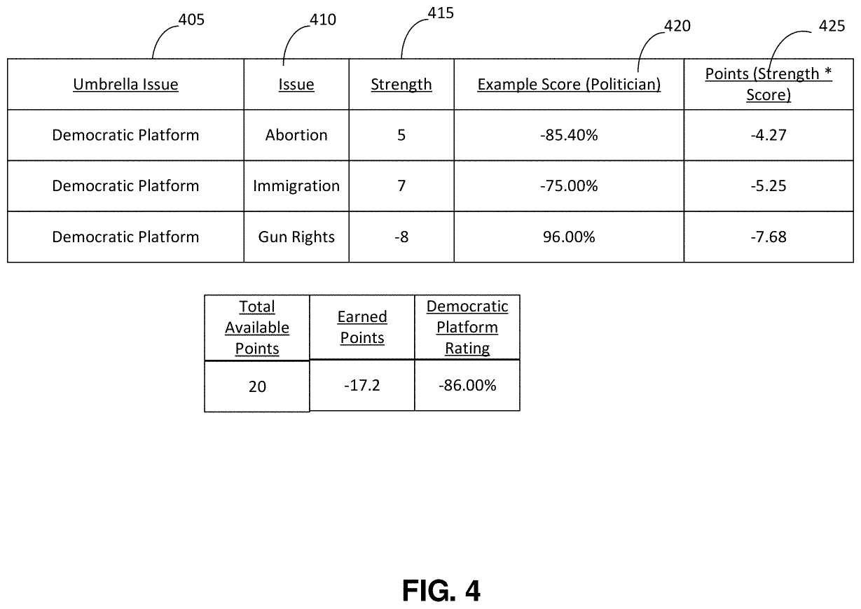

Scoring for umbrella issues are largely the same methodology as for individual issues. FIG. 4 depicts a limited fictional example depicting a politician's stances on various issues that make up an exemplary umbrella issue of the Democratic Party Platform.

In the example of FIG. 4, the Democratic Platform is the umbrella issue shown in column 405, consisting of three individual issues shown in column 410: abortion, immigration, and gun rights. As would be understood by persons of ordinary skill in the art, an umbrella issue can have any number of individual issues within it. A designated strength score is shown in column 415, the strength score representing a number of points commensurate to how important the individual issue is to the umbrella issue. In the example of FIG. 4, the strength score can range from −8 to 8. Affirmative positions on the issue are designated a positive score, while negative positions on the issue are designated a negative score. Thus, column 415 depicts pro-abortion, pro-immigration, and anti-gun rights positions.

Next, column 420 lists a politician's score for each individual issue. In example FIG. 4, a staunch Republican is used as the politician being scored for affinity to the umbrella issue of the Democratic Party Platform, hence the negative scores for abortion and immigration, and positive score for gun rights. Using the politician's stances on these three issues, system 102 calculates his score by first multiplying his score on each issue with the strength of the umbrella issue's stance on each issue. Next the points for each issue are summed to get −17.2. The total points available are calculated by summing the absolute value of all strengths, which is 20 (5+7+8). Dividing points earned by points available gives a score of −86% agreement of the politician with the umbrella issue of Democratic Party Platform.

Categories

Each issue 202 present in the issues database 110 of system 102 may further have one or more categories. These are used for display organization and typically have no score or values. They essentially function as text based tags to allow the system to depict issues of system 102 in a more user friendly manner. Exemplary categories may be healthcare, education, immigration, gun rights, etc.

Scoring a Politician

Using the system and methodologies discussed herein, a quantitative score can be determined to represent an entity's true position on an issue, rather than just what the entity publicly proclaims its position on the issue to be. For example, for a politician, a quantitative score can be determined based on his/her campaign contributions, voting record, special interest group ratings, and public positions.

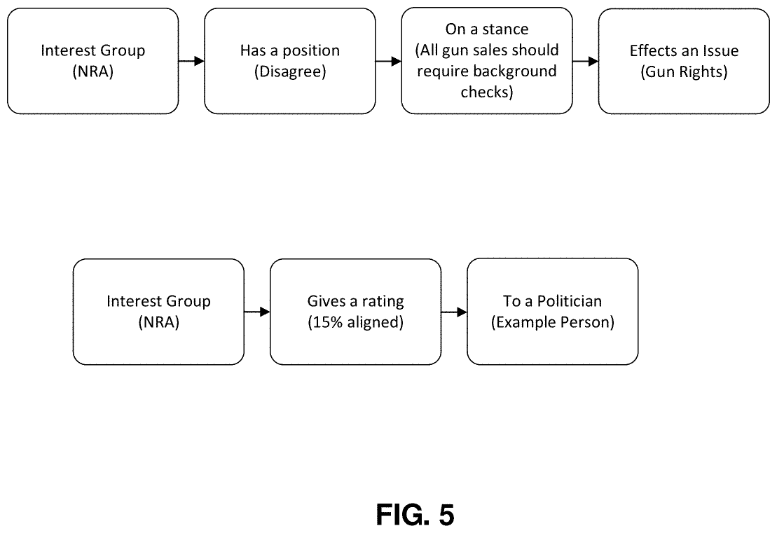

FIG. 5 depicts exemplary data relationships in database 110 of system 102 between interest groups, positions, stances, issues, and politicians. As shown in FIG. 5, an interest group has a position on a stance that affects an issue. In one example, an interest group is the National Rifle Association (NRA), which has a position of disagreeing with a stance that all gun sales should require background checks, for the issue of gun rights. Further, the interest group gives a rating to a politician representing how well the politician is aligned with this position on the stance for the issue.

Exemplary Profiles Depicting Issue Ratings

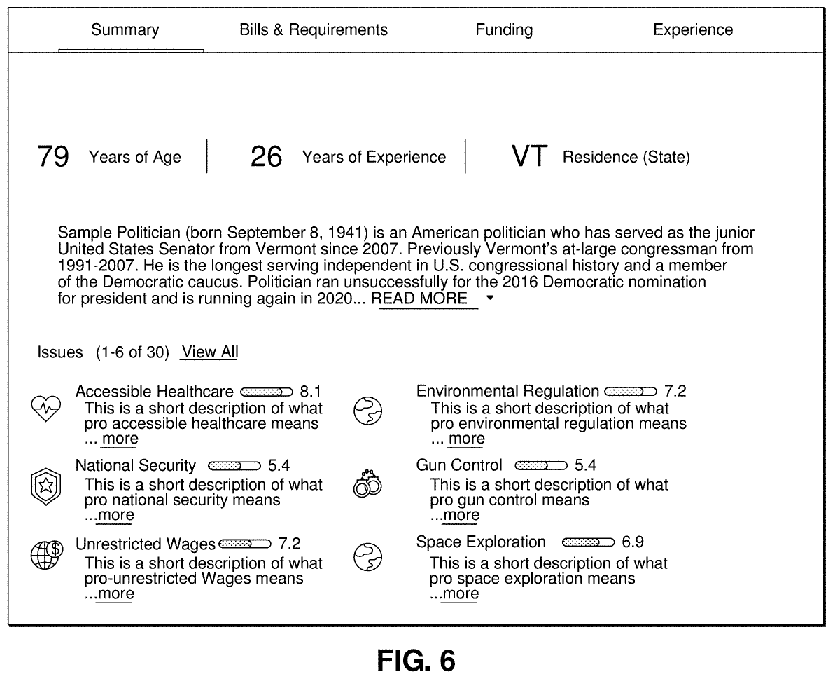

FIG. 6 depicts an exemplary politician profile that may be displayed on a graphical user interface of client user device 116. The politician's age, years of experience, and state of residence are depicted. In addition, a text description is provided about the person. Further, the bottom half of the graphical user interface displays the first six of thirty issues for which the politician has been rated by system 102. For accessible healthcare, the politician has been given a sample score of 8.1 out of 10, and for gun control the politician has been given a sample score of 5.4 out of 10. Each of the scores for the various issues for the politician can be determined by the system 102 as discussed herein, such as by factoring in campaign contributions from different people and groups, voting record, special interest group ratings, and public positions taken by the politician.

As would be understood by persons of ordinary skill in the art, there may be additional or fewer fields of information presented on a politician profile than those depicted in exemplary FIG. 6.

In various embodiments, the politician's profile page also shows a politician's most strongly-rated (and/or high-relevance) issues. The displayed GUI includes the issue names and description, along with the politician's calculated rating for the issue. Generally, the issue component is written in such a way as to support issue rating and the upcoming user alignment measurement, using the former as a fallback when alignment is unavailable, or the user is not authenticated in system 102.

The Key Issues section of the profile page may also include a link to expand the list to show all the politician's top-rated issues. To retrieve issue data for a given vid, the system accesses an endpoint in the issues service, as discussed herein with reference to caching of ratings.

In exemplary embodiments, the profile page shows the high-relevance and strongest-rated issues first, the issues tab may be presented in a profile navigation bar, and the key issues section shows a small of issues with a link to view all issues that expands the list to depict the rest of the politician's issues.

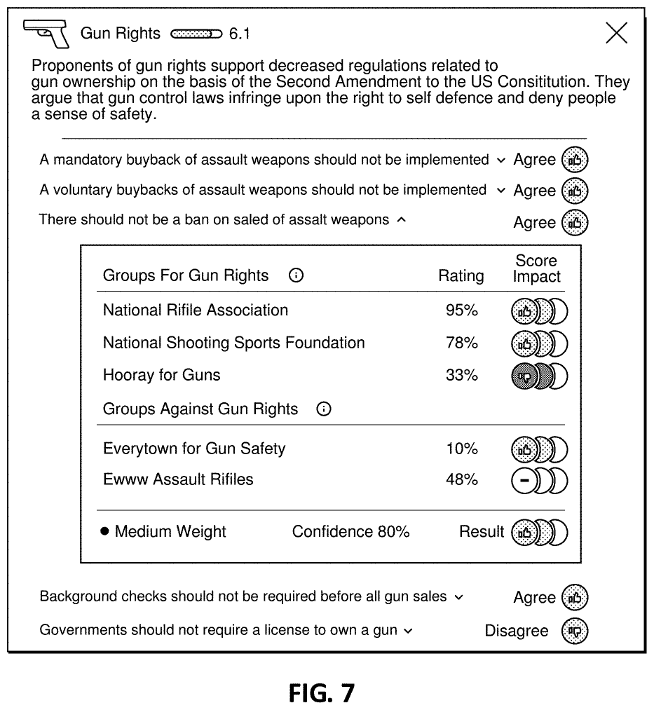

FIG. 7 depicts an exemplary detailed profile for an issue that may be displayed on a graphical user interface of client user device 116. In the exemplary figure, more detail is provided to show how the score of 6.1 for the issue of gun rights was determined for the Sample Politician. As would be understood by persons of ordinary skill in the art, there may be additional or fewer fields of information presented in various embodiments than those depicted in exemplary FIG. 7.

In the exemplary figure, a brief description is provided about the issue. Specific stances and positions held by the politician are also shown for the issue. In addition, the ratings provided by each of five different special interest groups for the politician's affinity for the issue is shown, along with an icon depicting each group's impact on the overall score for the politician. Thus, multiple interest groups each have their own stances and their own ratings on issues. Then they rate a politician and when the system 102 aggregates this information, it yields a final score for that politician's affinity to the issue. Quantifying these pieces of information using a unique algorithm yields the final score of 6.1 for Sample Politician for the gun rights issue. Thus, with this methodology, an end user can see not only what the politician's score is, but also the specific items of information that were quantified and aggregated to generate that score, which is important for transparency and generating trust and confidence in the numerical issue rating.

Deriving Ratings

In some cases, a politician may have taken no public position on a particular issue. Nevertheless, the disclosed system 102 can derive a numerical rating for the politician representing the politician's stance on the issue.

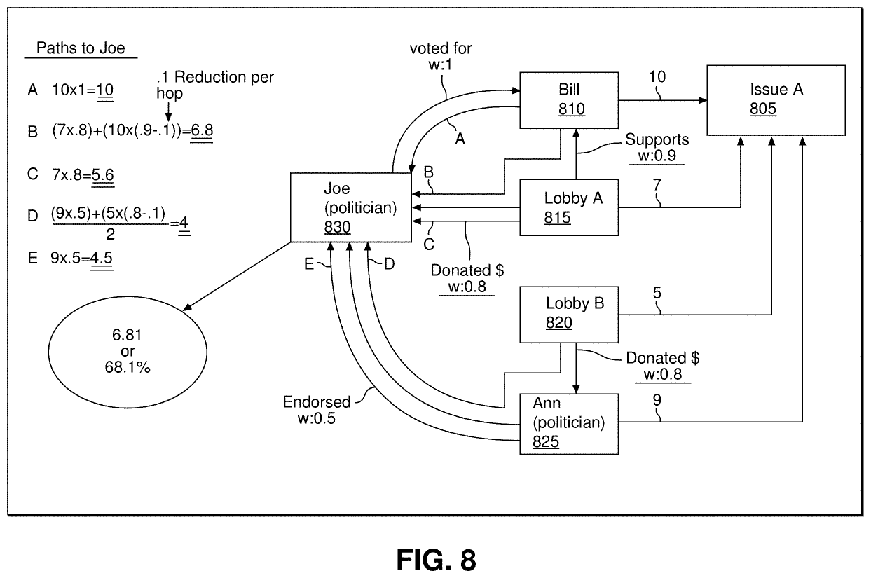

FIG. 8 depicts an exemplary method for deriving exemplary politician Joe's stance (and corresponding rating) on Issue A, reference number 805 in the exemplary figure. To derive the issue rating, the system builds a relationship database based on a graph between all the political entities.

The exemplary figure depicts that Issue A 805 was discussed in a piece of legislation, Bill 810. Also, others connected to Joe have taken a position on Issue A 805, including Lobby Group A 815, Lobby Group B 820, and Ann (politician) 825. Further, Bill 810 has previously been rated a 10 for Issue A 805, Lobby Group A 815 has previously been rated a 7 for Issue A 805, Lobby Group B 820 has been previously rated a 5 for Issue A 805, and Ann 825 has previously been rated a 9 for her support for Issue A 805. These previous ratings may have been by system 102 itself, or by other entities.

In the exemplary figure, each relationship has a type of relationship, and each type of relationship also has an associated weight. Voting for a bill is accorded a weight of 1.0, supporting a bill is accorded a weight of 0.9, donating money to a person is accorded a weight of 0.8, and endorsing a person is accorded a weight of 0.5. The actual values for the weights may vary in other embodiments—these weights are used here for purposes of illustration only. Further, there may be fewer or additional relationship types in other embodiments than those shown in exemplary FIG. 8.

FIG. 8 shows that since Joe 830 voted for Bill 810, he is accorded a weight of 1.0 in the exemplary figure. Thus, path A from Joe 830 to Issue A 830 is calculated as 10 (since 10 is the maximum point value available for each link in the exemplary graph of FIG. 8). Lobby Group A 815 has donated money to Joe 830, and they also support Bill 810. Thus, path B from Issue A 805 to Joe 830 is calculated as 6.8. Lobby Group B 820 has donated money to Ann 825, they are neutral in support of Issue A 805 with a rating of 5, and Ann 825 has publicly endorsed Joe 830.

Viewing all these relationships in the aggregate, the system can trace out all the different paths to Joe 830 from Issue A 805. In this exemplary figure, paths A, C, and E are direct paths, while paths B and D are indirect paths since they have a hop in between. From this, a score can be derived by averaging the total of the ratings times the weights. Further, the exemplary figure shows a 0.1 reduction in weighting for each hop. However, the hop reduction value can be any number in other embodiments. Further, the hop reduction value can be logarithmic. In general, the further away the relationship (the more indirect the relationship) from the politician (or other entity) being scored, the less weight it is accorded.

Using the relationship graph, the derived rating for Joe 830 for Issue A 805 is 6.81. Alternatively, the system 102 may present the information on client user device 120 by saying that there is a 68.1% confidence that Joe 830 has a positive position on Issue A 805. In this way, a derived rating for Joe 830 is generated for the issue based on his relationships with other entities only and no direct stance on that issue.

While FIG. 8 depicts only a few types of relationships and entities, a similar methodology is utilized for any type of relationship or entity. For example, the relationship graph may include any combination of one or more of: politician, legislation (bills, measures, referendums), organization that is receiving money through legislation, lobby group, special interest group, PAC (political action committee), super PAC, trade unions, think tanks, media publication, a celebrity, any other lay person, etc. Simply put, any entity in the political space that may have a viewpoint on an issue could be on the relationship graph.

Further, entities related to Joe can be things Joe voted for, people that he knows, and/or people giving him money. Also, entities that rate others for issues, such as special interest groups can have different types of relationships. For example, a lobby group can endorse someone, or they can donate money to them. Each of these types of relationships with the lobby group can be weighted differently in the relationship graph.

Exemplary User Interfaces for Groups

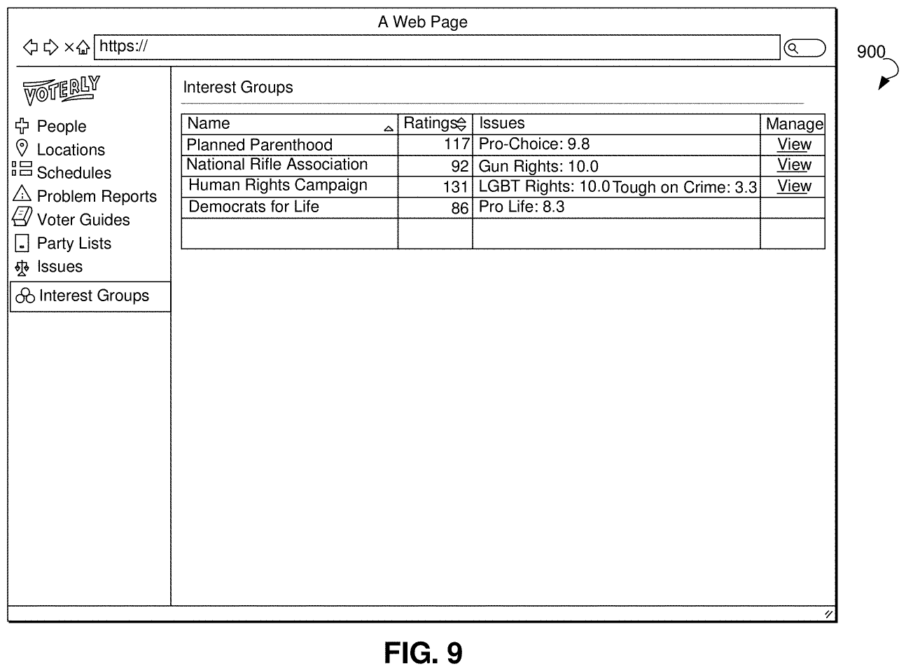

FIG. 9 depicts an exemplary graphical user interface 900 that may be displayed on a client user device 120. While the exemplary GUI 900 is depicted as a web page viewed through a web browser, the information may instead be presented in a dedicated software application operating on client user device 120. Further, there may be fewer or additional fields of information present on GUI 900 in other embodiments, than those depicted in the exemplary figure.

Exemplary GUI 900 depicts four special interest groups in one column, the number of ratings generated by each of those groups in another column, the particular issues that each interest group lobbies for in a third column, along with the group's score for their affinity with those issues. A client user 114 may select a group, rating, or issue column to get further detailed information. An administrative user 118 may select a group, rating, or issue column to view or edit any of the information. Alternatively, some or all this data for each interest group may be entered by a representative of each interest group, or automatically transferred over network 112 from the interest group.

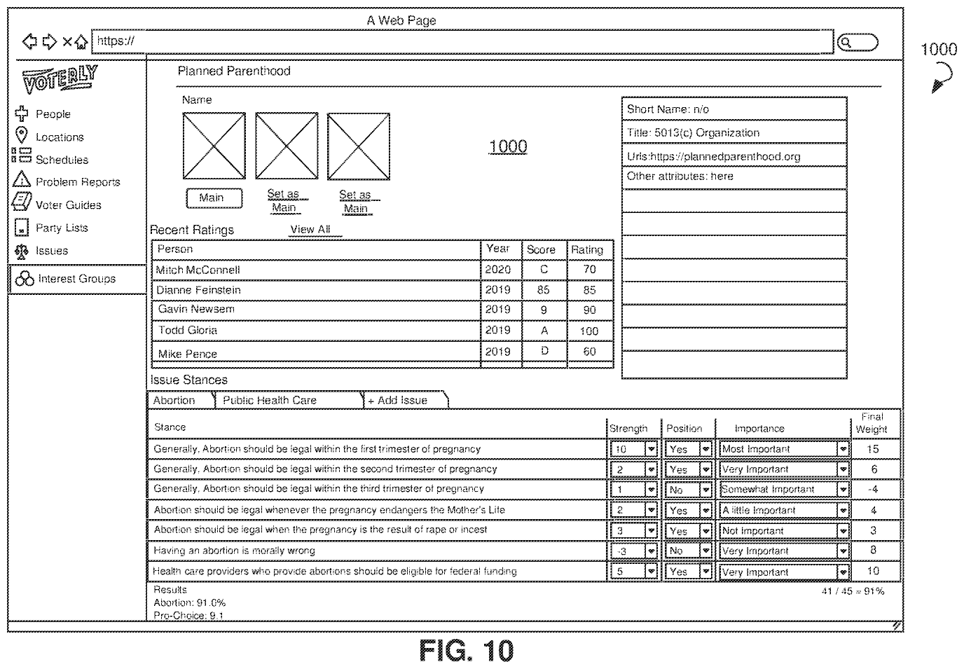

FIG. 10 depicts an exemplary graphical user interface 1000 that may be displayed on a client user device 120. While the exemplary GUI 1000 is depicted as a web page viewed through a web browser, the information may instead be presented in a dedicated software application operating on client user device 120. Further, there may be fewer or additional fields of information present on GUI 1000 in other embodiments, than those depicted in the exemplary figure.

Exemplary GUI 1000 depicts information about interest group “Planned Parenthood”, recent ratings given by the organization to other entities, as well as issue stances held by the organization for each issue that it advocates for.

While not expressly depicted in GUI 1000, there may also be a section that lists the latest n ratings given by the organization, where n is preferably between 5-10, though this number may be configurable by an administrative user 118. The recent ratings section may show the top n most recent ratings, sorted by year and/or by entity name. The recent ratings may show a rated entity, year, raw score from interest group, and/or normalized rating provided by system 102. In some embodiments, even though only the recent n ratings are shown, all available ratings may be depicted upon selection of a “View All” option on GUI 1000 by a user.

Further, an interest group may access system 102 through an API endpoint to return all ratings it has given, optionally limited by year. In other embodiments, a different route is provided by the API to support retrieving the latest ratings only from the interest group, such as: GET/interest-group/ratings/:interestGroupId/latest/:limit?.

The Issue Stances section of GUI 1000 displays the issues associated with the interest group beneath the recent ratings. This section lists all the stances for each issue and allows an administrative user 118 to edit the group's position on and importance of each stance. It also includes a means of adding and removing issues to/from a group.

In exemplary embodiments, a position's importance field on GUI 1000 can be one of a predefined set of values. For example, 4—Most Important, 3—Very Important, 2—Somewhat Important, 1—A Little Important, and 0—Not Important.

Generally, “Somewhat Important” is used as the default value, and does not affect the final weight for the stance. The other values are configurable by an administration user 118 of system 102.

Further, while positions are depicted in GUI 1000 as being either a yes or a no, they are not actually simple binary values in system 102. Rather, positions combine the yes/no choice with the importance modifier to create an integer value that is added to the stance's weight.

When an issue is linked to a special interest group, GUI 1000 will display all the stances for the issue. The group's positions must be filled out on GUI 1000 manually by an administrative user 118. Further, while strength is shown as an editable field in GUI 1000, the strength value may be a non-configurable value in some embodiments.

In various embodiments, an admin API route or routes is utilized to create/break the link between a special interest group and an issue. GUI 1000 then updates to reflect the change once the link is made or broken. In an administrative user interface, a “Remove Issue” button may also be present to allow unlinking an issue from a special interest group. Thus, API routes may also be provided in the interest group service of system 102 for linking/unlinking issues and special interest groups. For example, POST/interest-group/admin/issue-link/:interestGroupId and DELETE/interest-group/admin/issue-link/:interestGroupId. The body of requests to these endpoints contain the issues to link/unlink.

API routes can also be added in the issues service to update an interest group's position for each stance. For example: PUT/issues/admin/:issueId/position/:entityId and DELETE/issues/admin/:issueId/position/:entityId. The body of requests to these two endpoints contain the changes to stance positions—stance ID, position ID (if updating), position value, etc. In the user interface, a stance can be unlinked by providing a “None” option for position. The display of each issue in GUI 1000 also includes a calculation of the group's raw score for the issue and a user-friendly rating.

Thus, in GUI 1000, a section shows tabs for each connected issue, and each tab lists issue stances. A user can edit Position and Importance fields of each stance. The position document is updated in database 110 when Position or Importance fields are changed. Then, the final weight is calculated and displayed by system 102. Further, an overall issue rating is displayed (e.g., “Pro Choice: 9.1”).

Clicking “Add Issue” link/button opens issue-selection dialog. The issue-selection dialog uses typeahead search box to add issues. Multiple issues can be added from issue-selection dialog at one time. Issues can be removed from an interest group by pressing “Remove Issue” button. The remove Issue button deletes issue key from interest group's list and deletes all related positions.

While not expressly depicted in GUI 1000, there may be additional issue fields present in some embodiments, to allow for more flexibility in which issues are displayed. For example, there may be a field called “status” which can take values of “live” or “in progress”, among other things. This field may denote whether the issue is ready to show in the UI. An example use case for this would be an issue that was just created, but still has its stances being defined. In this case, the issue is not displayed in GUI 1000 until the stances are finalized. The “in progress” value may be the default value for the “status” field.

Another additional field may be called “relevance” and helps an administrative user 118 determine which issues are to be shown in the UI. It may contain a value of “low, normal” (the default) or “high”. High relevance issues may be prioritized while low-relevance ones may be rarer. Any sorting algorithm that factors in this relevance may be in a reusable/easy-to-change location so the algorithm can be improved later.

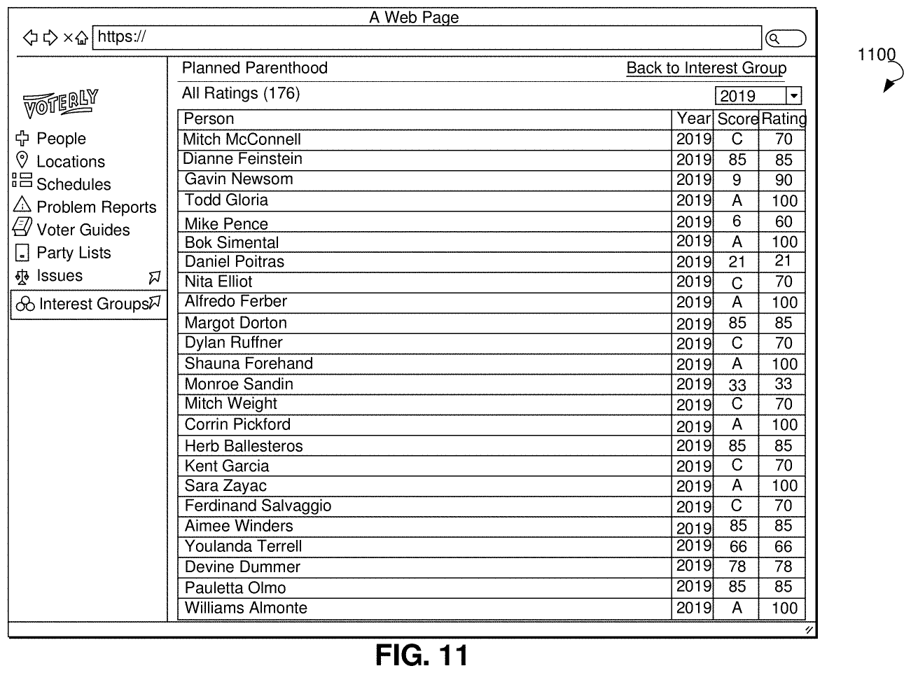

FIG. 11 depicts an exemplary graphical user interface 1100 that may be displayed on a client user device 120. While the exemplary GUI 1100 is depicted as a web page viewed through a web browser, the information may instead be presented in a dedicated software application operating on client user device 120. Further, there may be fewer or additional fields of information present on GUI 1100 in other embodiments, than those depicted in the exemplary figure.

Exemplary GUI 1100 depicts information about ratings provided by an interest group “Planned Parenthood” to other entities. In exemplary embodiments, GUI 1100 shows all ratings for the selected interest group, including the total count of ratings in the heading. Further, the ratings can be filtered by year. In an exemplary embodiment, the list can be sorted according to a hierarch, such as Person surname>Person first name>Year, all ascending. GUI 1100 also includes a link to return to the previous interest group page, GUI 1000.

Further, GUI 1100 shows that the interest group provides a numerical rating for some persons, and an alphabetical rating for other persons. System 102 converts the interest group scoring system into a normalized rating value depicted in GUI 1100.

Issue Ratings

Individual positions/stances can be assigned in database 110 to politicians or other entities manually or automatically. Further, interest group rating data can be utilized as a gauge for the entity's overall position on an issue. For example, if Ponies Unite USA is a special interest group that supports ponies, and they give Sample Politician an 100% rating on ponies, the system 102 can display Sample Politician's rating as 10.0 even though system 102 does not have granular data for Sample Politician's actual positions on pony issues. Further, each interest group's pony ratings for Sample Politician can be aggregated and/or averaged to show a value for Sample Politician with a reasonable confidence level.

As discussed herein, in various embodiments of the present system 102, special interest groups are connected to issues—even if the group's positions on the connected issue stances are not known/entered (for issue ratings the link is all we need).

Calculating Issue Ratings for Interest Groups

As used herein, an “issue rating” is the ratio of the sum of an entity's position scores to the maximum possible stance score. For an interest group, if the variable i is a position's importance and the variable M is the stance modifier constant, the position weight wₚ can be described as: wₚ=Mi. The variable s can represent a sign of the group's position, where 1 is for an affirmative position (yes) and −1 is for a negative position (no). Thus, the final stance position score p can be defined as: p=s(wₛ+wₚ).

For each p calculated as above, the total sum of scores for an issue can be expressed as p. The maximum stance score is the sum of the combined weights before applying the sign (i.e., wₛ+wₚ) of all positions for the issue. This is essentially the score a group would receive if every position they took on the issue was a Yes. Then the issue rating R for an entity can be determined as: R=10*p÷(wₛ+wₚ). The result of this division operation will range between −1 and 1 inclusive (−100% for total disagreement and 100% for total agreement). Generally, the system stores the rating in a range of [−10.0, 10.0], so the value is multiplied by 10.

The stance modifier M is a configuration value that determines how much a position weight affects the final stance weight. In other words, it scales the importance values. Values greater than 1 amplify the position's effect, while values less than 1 dampen the effect. In preferred embodiments, the stance modifier defaults to a value of 1.

Using these equations, a final rating value can be calculated for each issue connected with an interest group. If an interest group does not have positions saved for every stance of an issue, then only the ones for which positions are available may be used to determine the rating.

Calculating Issue Ratings for People

To calculate an issue rating for a person, the system 102 calculates issue ratings for each issue as scored by each relevant interest group. Then the person's average issue rating may be the mean of all interest groups' ratings for that issue. This mean rating can be standardized into the expected [−10.0, 10.0] issue rating range. In some embodiments, a simple linear transformation can be used to convert ratings in the range [0, 100] to [−10, 10]. Then the person's final issue rating R will be: R=20*(R_{avg}÷100)−10 where R_{avg} is the mean issue rating. This conversion can be implemented in its own method so other equations for standardization or normalization may be used in other embodiments.

As discussed herein, some organizations give out letter grades instead of numeric ratings. In one example embodiment, these letter grades can be converted into numeric ratings using the following conversions: A=100, B=75, C=50, D=25, F=0.

The algorithm for calculating ratings may be kept in a modular location in system 102, to allow for tweaks to it over time. For example, some interest groups may be assigned a higher weight due to their authority on an issue in question. System 102 accepts the ID of a person and returns a data object containing data regarding issues on which the person is rated. An exemplary format of this object is described below.

In one example embodiment, the rating-aggregation algorithm for people may be like the below code, though optimizations/other approaches may also be utilized:

```
public calculatePersonRatings(personVid: string): { [issueId: string]:
IssueRatingDetails} {
  // Get all ratings for the person
  // Map ratings to interest group IDs, keeping only the most recent
rating
  // We want to keep this association because we want the option of
displaying it in the UI
  // Map from issue ID to a list of ratings
const issueRatingMap: { [issueId: string]: InterestGroupRating[ ] }
= { };
  // For each interest group in the above
    // Look up the interest group and cache if in memory if we
haven't already
    // Get the issues the group rates on
    // For each issue
      // Look up the issue details and cache them in memory it we
    haven't already
      // Calculate the rating based on the formula above
      // Add the rating to the issue-rating map
  // Map issue ID to rating details
  const issues: { [issueId: string]: IssueRatingDetails } = { };
  // For each issue in issueRatingMap:
    // Calculate the average of all ratings in the list
    // Standardize/normalize the rating to [−10.0, 10.0]
    // Add the result to the issues list
    // Fill in the extra issue and position data
  return issues;
}
```

The result of this method will contain a list of IssueRatingDetails objects, keyed on issue ID. The interface should contain at least the following information:

```
export interface IssueRatingDetails {
  // Entity's issue rating (avg. for person, calculated for interest
group)
  rating: number;
  // Name of the rated issue
  issueName: string;
  // Issue description (surprise!)
  issueDescription: string;
  // The entity's position on the issue (e.g., “pro choice” or “pro
life”)
  position: string;
  // Description of the position
  positionDescription: string;
  // List of all interest groups that gave the person a rating on the issue
  // Optional because it is unneeded for an interest group
  ratingInterestGroups?: { [interestGroupId: string]: { name: string,
  rating: number } };
}
```

In the above described exemplary computer code, calculatePersonRatings( ) returns a list of compiled issue ratings keyed on interest group ID, and the IssueRatingDetails object contains enough information for full-featured display in UI.

Caching Ratings

In some embodiments, a map of issues to ratings for each person can be created and stored in database 110 of system 102, to avoid repeatedly recalculating information that is not likely to change often. This document can be created the first time it is needed, for example when a politician's profile is accessed, then simply loaded subsequently. This document may also expire periodically, after the passage of a configurable amount of time. In some embodiments, the document expires upon the expiration of a fairly short first interval (such as 2 weeks), then the interval is increased later once the stances and ratings calculations are finalized.

An API route can be created to take an entity's ID and return a list of calculated ratings, for example: GET/issues/for/:vIdList.

Retrieving a list of ratings for a single entity may execute computer code similar to:

```
public getEntityRatings(entityVid: string): { [issueId: string]:
IssueRatingDetails } {
  // Look up the entity; return early if we cannot find it
  // Look up the cached rating document
  // If it does not exist, calculate ratings and create it
  // If the rating document is expired, schedule a rebuild
  // Return the ratings data
}
```

In this way, getEntityRatings( ) validates entity existence and type, calculates nonexistent ratings, and returns an empty object if no ratings are found. In various embodiments, the collection returned by this method contains all the details necessary to display a robust issue breakdown of the entity in the client UI.

Computing System

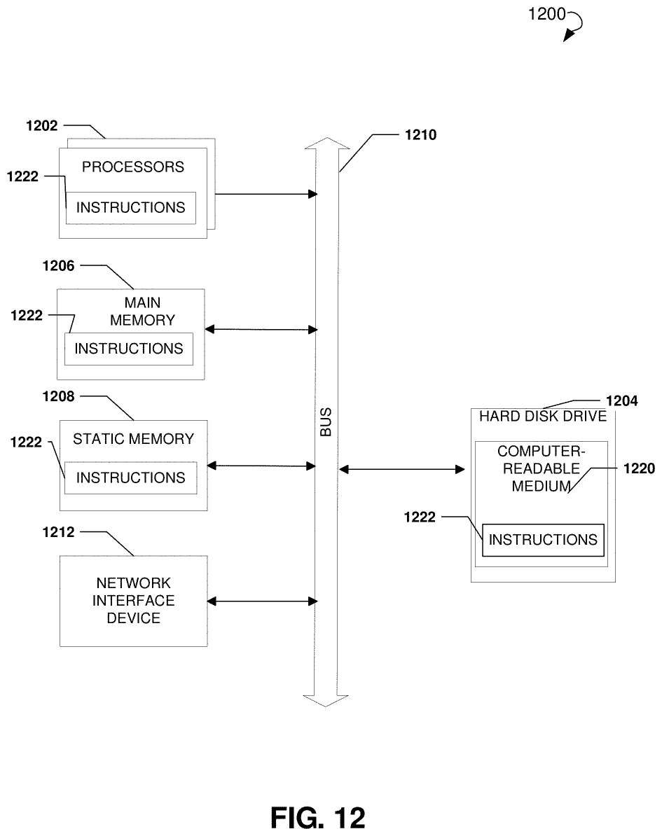

Various embodiments of the present technology can be practiced with a local computer system, and/or a cloud-based system. FIG. 12 shows a diagrammatic representation of a computing device for a machine in the exemplary electronic form of a computer system 1200, within which a set of instructions for causing the machine to perform any one or more of the methodologies discussed herein can be executed. Computing device 1200 may be administrative user device 120, client user device 116, server(s) 104, or any other computing device discussed herein.

In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a server, a personal computer (PC), a tablet PC, a set-top box, a cellular telephone, a digital camera, a portable music player (e.g., a portable hard drive audio device, such as a Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor or multiple processors 1202, a hard disk drive 1204, a main memory 1206 and a static memory 1208, which communicate with each other via a bus 1210. The computer system 1200 may also include a network interface device 1212. The hard disk drive 1204 may include a computer-readable medium 1220, which stores one or more sets of instructions 1222 embodying or utilized by any one or more of the methodologies or functions described herein. The instructions 1222 can also reside, completely or at least partially, within the main memory 1206 and/or the static memory 1208 and/or within the processors 1202 during execution thereof by the computer system 1200. The main memory 1206, the static memory 1208, and the processors 1202 also constitute machine-readable media.

While the computer-readable medium 1220 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, RAM, ROM, and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, C, Python, JavaScript, Go, or other compilers, assemblers, interpreters or other computer languages or platforms.

The processing for various embodiments may be implemented in software that is cloud-based. In some embodiments, the computer system 1200 is implemented as a cloud-based computing environment, such as a virtual machine operating within a computing cloud. In other embodiments, the computer system 1200 may itself include a cloud-based computing environment, where the functionalities of the computer system 1200 are executed in a distributed fashion. Thus, the computer system 1200, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer system 1200, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the systems and methods provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), any other optical storage medium, RAM, PROM, EPROM, a FLASHEPROM, any other memory chip or cartridge.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be coupled with the user's computer through any type of network, including a local area network (LAN), a wide area network (WAN), a Metropolitan Area Network (MAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products, according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, systems and methods for computational quantification of an entity's affinity to a qualitative issue defined with Boolean data are described herein. While various embodiments have been described, they have been presented by way of example only, and not limitation. The descriptions are not intended to limit the scope of the technology to the forms set forth herein. Thus, the breadth and scope of a preferred embodiment should not be limited by any of the above-described exemplary embodiments. The above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the present technology should, therefore, be determined not with reference to the above description, but instead should be determined with reference to the appended claims along with their full scope of equivalents.

1. A computer-implemented method for determining a quantitative score value that represents a first entity's qualitative affiliation with a political issue, the method comprising:
receiving, by a processor, a selection of a political issue;
defining, by the processor, a plurality of affirmative stances for the political issue;
allocating, by the processor, a strength number to each of the plurality of affirmative stances, each strength number representing the affirmative stance's importance to the political issue;
allocating, by the processor, a position to each affirmative stance, the position representing a first entity's agreement or disagreement with the affirmative stance, the position being determined based on information concerning the first entity, the information being stored in a relationship database;
determining, by the processor, a numerical strength value for each of the plurality of affirmative stances, the numerical strength value being either the strength number for the affirmative stance, or an invert of the strength number for the affirmative stance;
determining, by the processor, a quantitative score value that represents the first entity's qualitative affiliation with the political issue based on a ratio of summed numerical strength values compared to summed strength numbers;
caching, the quantitative score value that represents the first entity's qualitative affiliation with the political issue, in a database, wherein the caching includes:
looking up a cached rating document;
storing the quantitative score value that represents the first entity's qualitative affiliation with the political issue in a new or rebuilt cached rating document; and
storing the new or rebuilt cached rating document in a database, wherein the new or rebuilt cached rating document may be accessed from the database to avoid repeatedly recalculating information;
looking up the first entity in the new or rebuilt cached rating document to access the quantitative score value that represents the first entity's qualitative affiliation with the political issue; and
displaying the quantitative score value that represents the first entity's qualitative affiliation with the political issue via a graphical user interface to an end user on a computing device, the quantitative score displayed updating based on the cached rating document in the database.

2. The method of claim 1, wherein the first entity is one of a: politician, celebrity, lay person, lobbying group, special interest group, trade union, think tank, media publication, political action committee, or a super political action committee.

3. The method of claim 1, wherein the numerical strength value for each affirmative stance is a value between −10 to 10.

4. The method of claim 1, wherein the quantitative score value that represents the first entity's qualitative affiliation with the political issue is between 0%-100%.

5. The method of claim 1, wherein the political issue is characterized by a database object comprising at least four properties: the issue name, an affirmative label, a negative label, and a Boolean property invert.

6. The method of claim 1, wherein each affirmative stance for the political issue has a corresponding negative stance representing the opposite viewpoint.

7. A computer-implemented method for determining a quantitative score value that represents a first entity's qualitative affiliation with an umbrella issue, the method comprising:
receiving a selection of an umbrella issue, the umbrella issue comprising a plurality of distinct political issues;
allocating a strength number to each of the political issues, each strength number representing the political issue's importance to the umbrella issue;
multiplying the first entity's quantitative score value for each political issue with the strength number for said political issue to determine a number of points for each political issue; and
determining a score value representing the first entity's qualitative affiliation with the umbrella issue based on a ratio of summed points for each political issue compared to summed strength numbers.

8. The method of claim 7, wherein the first entity is one of a: politician, celebrity, lay person, lobbying group, special interest group, trade union, think tank, media publication, political action committee, and a super political action committee.

9. The method of claim 7, wherein the strength number for each political issue is a value between −10 to 10.

10. The method of claim 7, wherein the quantitative score value that represents the first entity's qualitative affiliation with the umbrella issue is between 0%-100%.

11. The method of claim 7, further comprising: displaying the quantitative score value that represents the first entity's qualitative affiliation with the umbrella issue via a graphical user interface to an end user on a computing device.

12. The method of claim 7, wherein the political issue is characterized by a database object comprising at least four properties: the issue name, an affirmative label, a negative label, and a Boolean property invert.

13. A computer-implemented method for determining a quantitative score value that represents a first entity's qualitative affiliation with a political issue, the method comprising:
determining a plurality of other entities affiliated with the first entity, each of the plurality of other entities having a predetermined score value for their own affiliation with the political issue;
determining a type of relationship between the first entity and each of the plurality of other entities affiliated with the first entity;
determining a numerical weighting for each type of relationship;
generating a relationship graph to map an affiliation between the first entity and each of the plurality of other entities;
calculating a numerical score value for each direct path and each indirect path on the relationship graph from the political issue to the first entity; and
aggregating the numerical score value for each path to determine a quantitative score value representing the first entity's qualitative affiliation with the political issue.

14. The method of claim 13, wherein the numerical weighting for an indirect path is less than the numerical weighting for a direct path.

15. The method of claim 13, wherein the first entity is one of a: politician, celebrity, lay person, lobbying group, special interest group, trade union, think tank, media publication, political action committee, and a super political action committee.

16. The method of claim 13, wherein the other entities are at least one of a: politician, celebrity, lay person, lobbying group, special interest group, trade union, think tank, media publication, political action committee, super political action committee, and a piece of legislation.

17. The method of claim 13, further comprising: displaying the quantitative score value representing the first entity's qualitative affiliation with the political issue via a graphical user interface to an end user on a computing device.

18. The method of claim 13, further comprising: displaying the generated relationship graph via a graphical user interface to an end user on a computing device.

19. The method of claim 13, wherein the numerical weighting for a relationship type is variable based on relative placement on the relationship graph of the first entity compared to the other entity.

20. The method of claim 13, further comprising normalizing the quantitative score value that represents the first entity's qualitative affiliation with the political issue to a value between 0%-100%.

21. The method of claim 1, wherein at least one of the plurality of affirmative stances is associated with two or more political issues.

22. The method of claim 1, wherein each political issue-affirmative stance relationship is defined and stored in a database.

23. The method of claim 5, wherein the first entity's quantitative score value is negative before inversion, and the negative label is displayed via the graphical user interface.

24. The method of claim 5, wherein the first entity's quantitative score value is positive, and the affirmative label is displayed via the graphical user interface.

25. A non-transitory computer-readable storage medium having embodied thereon instructions, which when executed by a processor, perform steps of a method, the method comprising:
receiving, by the processor, a selection of a political issue;
defining, by the processor, a plurality of affirmative stances for the political issue;
allocating, by the processor, a strength number to each of the plurality of affirmative stances, each strength number representing the affirmative stance's importance to the political issue;
allocating, by the processor, a position to each affirmative stance, the position representing a first entity's agreement or disagreement with the affirmative stance, the position being determined based on information concerning the first entity, the information being stored in a relationship database;
determining, by the processor, a numerical strength value for each of the plurality of affirmative stances, the numerical strength value being either the strength number for the affirmative stance, or an invert of the strength number for the affirmative stance;
determining, by the processor, a quantitative score value that represents the first entity's qualitative affiliation with the political issue based on a ratio of summed numerical strength values compared to summed strength numbers;
caching, the quantitative score value that represents the first entity's qualitative affiliation with the political issue, in a database, wherein the caching includes:
looking up a cached rating document;
storing the quantitative score value that represents the first entity's qualitative affiliation with the political issue in a new or rebuilt cached rating document; and
storing the new or rebuilt cached rating document in a database, wherein the new or rebuilt cached rating document may be accessed from the database to avoid repeatedly recalculating information;
looking up the first entity in the new or rebuilt cached rating document to access the quantitative score value that represents the first entity's qualitative affiliation with the political issue; and
displaying the quantitative score value that represents the first entity's qualitative affiliation with the political issue via a graphical user interface to an end user on a device, the quantitative score displayed updating based on the cached rating document in the database.

26. The non-transitory computer-readable storage medium of claim 25, wherein the first entity is one of a: politician, celebrity, lay person, lobbying group, special interest group, trade union, think tank, media publication, political action committee, and a super political action committee.

27. The non-transitory computer-readable storage medium of claim 25, wherein the numerical strength value for each affirmative stance is a value between −10 to 10.

28. The non-transitory computer-readable storage medium of claim 25, wherein the quantitative score value that represents the first entity's qualitative affiliation with the political issue is between 0%-100%.

29. The non-transitory computer-readable storage medium of claim 25, wherein the political issue is characterized by a database object comprising at least four properties: the issue name, an affirmative label, a negative label, and a Boolean property invert.

30. The non-transitory computer-readable storage medium of claim 25, wherein each affirmative stance for the political issue has a corresponding negative stance representing the opposite viewpoint.

31. The non-transitory computer-readable storage medium of claim 25, wherein at least one of the plurality of affirmative stances is associated with two or more political issues.

32. The non-transitory computer-readable storage medium of claim 25, wherein each political issue-affirmative stance relationship is defined and stored in a database.

33. The non-transitory computer-readable storage medium of claim 25, wherein the first entity's quantitative score value is negative before inversion, and the negative label is displayed via the graphical user interface.

34. The non-transitory computer-readable storage medium of claim 25, wherein the first entity's quantitative score value is positive, and the affirmative label is displayed via the graphical user interface.

35. A system for determining a quantitative score value that represents a first entity's qualitative affiliation with a political issue, and displaying the results via a user-friendly interface, the system comprising:
a graphical user interface configured to:
receive a first entity's selection of a political issue; and
display a quantitative score value that represents the first entity's qualitative affiliation with the political issue the quantitative score displayed updating based a cached rating document;
a processor configured to:
define a plurality of affirmative stances for the political issue;
allocate a strength number to each of the plurality of affirmative stances, each strength number representing the affirmative stance's importance to the political issue;
based on the first entity's inputs, allocate a position to each affirmative stance, the position representing the first entity's agreement or disagreement with the affirmative stance, the position being determined based on information concerning the first entity, the information being stored in a relationship graph database;
determine a numerical strength value for each of the plurality of affirmative stances, the numerical strength value being either the strength number for the affirmative stance, or an invert of the strength number for the affirmative stance;
determine a quantitative score value that represents the first entity's qualitative affiliation with the political issue based on a ratio of summed numerical strength values compared to summed strength numbers;
look up the cached rating document in storage;
create, when a cached rating document is not found, a new cached rating document, wherein the new cached rating document is a map or list that may contain various quantitative score values, including the quantitative score value that represents the first entity's qualitative affiliation with the political issue;
rebuild, when a cached rating document is found to be expired, a rebuilt cached rating document, wherein the rebuilt cached rating document is a map or list that may contain various quantitative score values, including the quantitative score value that represents the first entity's qualitative affiliation with the political issue; and
look up the first entity in the new or rebuilt cached rating document to access the quantitative score value that represents the first entity's qualitative affiliation with the political issue; and
the storage configured to:
store a database object comprising at least four properties: the issue name, an affirmative label, a negative label, and a Boolean property invert;
store preset issues, affirmative stances, and strength numbers of the affirmative stances;
store the quantitative score value that represents the first entity's qualitative affiliation with the political issue in the new or rebuilt cached rating document; and
store the new or rebuilt cached rating document in a database, wherein the new or rebuilt cached rating document may be accessed from the database to avoid repeatedly recalculating information.
